(19) United States
(12) Patent Application Publication
(10) Pub. No.: US 2010/0128030 A1
(43) Pub. Date: May 27, 2010

(54) TRIANGULATION PROCESSING SYSTEMS AND METHODS

(75) Inventor: Chia-Ming Chang, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INSTITUTE FOR INFORMATION INDUSTRY, Taipei (TW)

(21) Appl. No.: 12/334,595

(22) Filed: Dec. 15, 2008

(30) Foreign Application Priority Data
Nov. 26, 2008 (TW) 97145681

(51) Int. Cl. G06T 15/00

(52) U.S. Cl. 345/419

(57) ABSTRACT

Triangulation processing systems and methods are provided. The system includes a vertex buffer, an angle calculator, an ear calculator, and a triangle selector. The vertex buffer includes a plurality of storage units to store information of a plurality of vertices of a polygon. Each storage unit has an indicator including at least an angle flag and an ear flag. The angle calculator calculates an angle type of the respective vertex, and records the angle type to the corresponding angle flag. The ear calculator determines whether the respective vertex is an ear of the polygon. If so, the corresponding ear flag is marked. The triangle selector selects one of the vertices with the marked ear flags, and clips the selected vertex from the polygon.

### CROSS REFERENCE TO RELATED APPLICATIONS

This Application claims priority of Taiwan Patent Application No. 097145681, filed on Nov. 26, 2008, the entirety of which is incorporated by reference herein.

### BACKGROUND OF THE INVENTION

1. Field of the Invention

The disclosure relates generally to triangulation processing systems and methods, and, more particularly to systems and methods that perform the triangulation of polygons utilizing a hardware-implemented or software-implemented indicator.

2. Description of the Related Art

In the field of computer graphic, a specification defines the basic processing unit for rendering 3D images is a triangle including three vertices. During rendering of a polygon, the polygon must be first divided into several triangles, and thereafter, each of the triangles is rendered. Triangulation is the procedure used to decompose a complex surface. For example, a polygon is decomposed into several simple triangles after a triangulation process.

Generally, a triangulation process analyzes a polygon, and accordingly determines a decomposition manner. When the triangulation process is completed, the generated triangles are output to a rendering unit for rendering. Conventionally, the triangulation process is performed via software. Since the triangulation process is complex and needs a huge amount of calculations, the efficiency of the triangulation process is a critical issue for triangulation efficiency. For some prior art inventions, a processor having high performance can be additionally used to perform the triangulation process. Adding a processor, however, increases costs for developers.

### BRIEF SUMMARY OF THE INVENTION

Triangulation processing systems and methods are provided.

An embodiment of a triangulation processing system includes a vertex buffer, an angle calculator, an ear calculator, and a triangle selector. The vertex buffer includes a plurality of storage units to store information of a plurality of vertices of a polygon. Each storage unit has an indicator including at least an angle flag and an ear flag. The angle calculator calculates an angle type of the respective vertex, and records the angle type to the corresponding angle flag. The ear calculator determines whether the respective vertex is an ear of the polygon. If the vertex is the ear of the polygon, the corresponding ear flag is marked. The triangle selector selects one of the vertices with the marked ear flags, and clips the selected vertex from the polygon.

In an embodiment of a triangulation processing method, information of a plurality of vertices of a polygon is received. Each vertex has at least an angle flag and an ear flag. Then, an angle type of the respective vertex is calculated according to the information of the vertices, and the angle type is recorded to the corresponding angle flag. It is determined whether the respective vertex is an ear of the polygon. If the vertex is the ear of the polygon, the corresponding ear flag is marked. Thereafter, one of the vertices with the marked ear flags is selected, and clipped from the polygon.

In some embodiments, each vertex further includes a clip flag. After the selected vertex is clipped from the polygon, the clip flag corresponding to the selected vertex is marked. The vertex with the marked clip flag is skipped in subsequent processing and determination.

In some embodiments, after the selected vertex is clipped from the polygon, the angle type of the respective vertex connected with the selected vertex is re-calculated, and recorded to the corresponding angle flag. Additionally, it is determined whether the respective vertex connected with the selected vertex is an ear of the polygon after the selected vertex is clipped (polygon without the selected vertex). If the vertex connected with the selected vertex is the ear of the polygon after the selected vertex is clipped (polygon without the selected vertex), the corresponding ear flag is marked.

Triangulation processing systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a triangulation processing system of the invention;

FIG. 2 is a schematic diagram illustrating an embodiment of a vertex buffer of the invention;

FIG. 3 is a schematic diagram illustrating an embodiment of a storage unit of the vertex buffer of the invention;

FIG. 4 is a schematic diagram illustrating an embodiment of an indicator of the invention;

FIG. 5 is a schematic diagram illustrating another embodiment of a triangulation processing system of the invention;

FIG. 6 is a flowchart of an embodiment of a triangulation processing method of the invention; and

FIGS. 7A˜7M are schematic diagrams illustrating an example of a triangulation process according to the embodiment of the invention.

### DETAILED DESCRIPTION OF THE INVENTION

Triangulation processing systems and methods are provided.

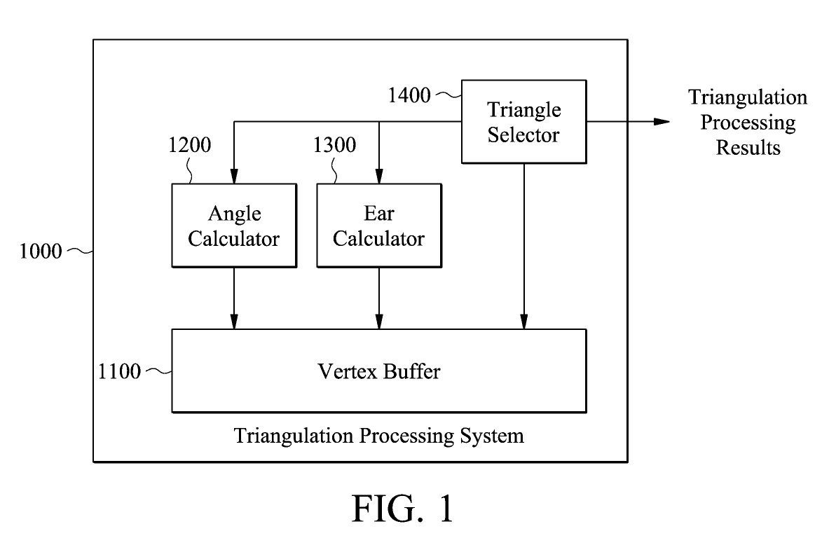

FIG. 1 is a schematic diagram illustrating an embodiment of a triangulation processing system of the invention.

The triangulation processing system 1000 comprises a vertex buffer 1100, an angle calculator 1200, an ear calculator 1300, and a triangle selector 1400.

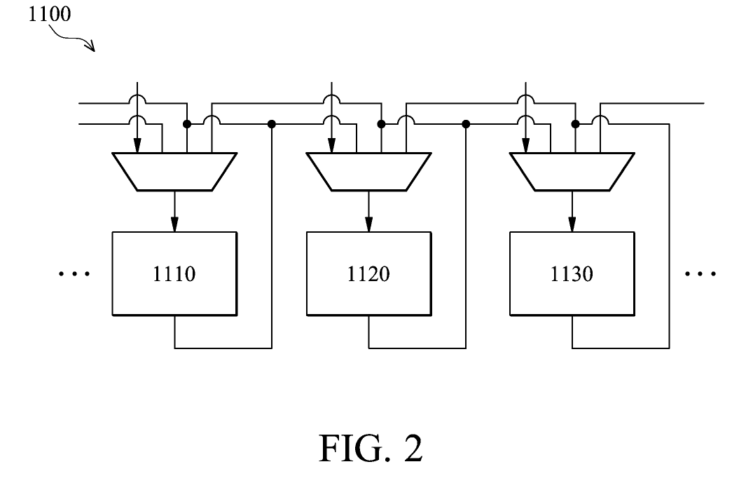

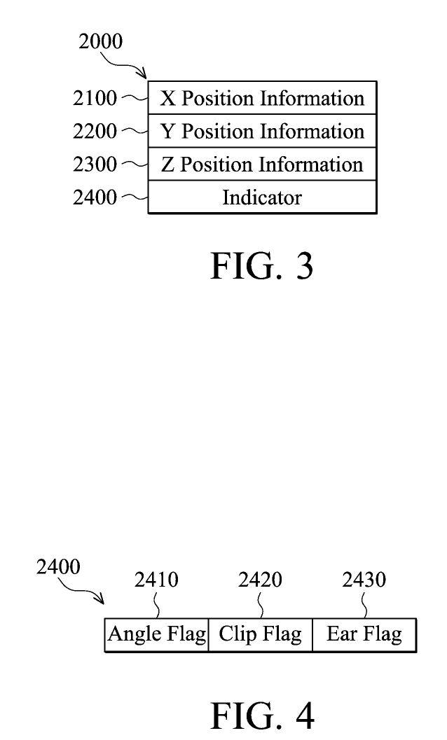

FIG. 2 is a schematic diagram illustrating an embodiment of a vertex buffer of the invention. As shown in FIG. 2, the vertex buffer 1100 may comprise a plurality of storage units (1110, 1120 and 1130), respectively storing information of a plurality of vertices of a polygon. Each storage unit may have at least 4 data units. For example, the storage unit 2000 has data units 2100, 2200 and 2300, respectively storing X position information, Y position information, and Z position information, and an indicator 2400, as shown in FIG. 3. The X position information, Y position information and Z position information respectively comprise coordinate at X, Y and Z axes of the vertex. FIG. 4 is a schematic diagram illustrating an embodiment of an indicator of the invention. As shown in FIG. 4, the indicator 2400 may comprise an angle flag 2410, a clip flag 2420 and an ear flag 2430. In some embodiments, the size of the indicator 2400 is 3 bits, respectively recording the angle flag 2410, the clip flag 2420 and the ear flag 2430. The usage of the angle flag 2410, the clip flag 2420 and the ear flag 2430 is discussed later.

The angle calculator 1200 can calculates an angle type of respective vertex, and records the angle type to the corresponding angle flag 2410. It is understood that, in some embodiments, the angle calculator 1200 can calculate the angle type of the respective vertex according to the information, such as coordinates of three connected vertices. It is noted that, the angle type comprises a convex angle and a reflex angle. It is assumed that vertices Pi−1, Pi and Pi+1 are connected. In the left-hand coordinate system, when the clockwise angle (interior angle) between a vector from vertex Pi to vertex Pi−1 and a vector from vertex pi to vertex Pi+1 is less than 180 degrees, the vertex Pi is a convex angle. When the clockwise angle (interior angle) between a vector from vertex Pi to vertex Pi−1 and a vector from vertex pi to vertex Pi+1 is greater than 180 degrees, the vertex Pi is a reflex angle. After the angle type of the respective vertex is obtained, the angle calculator 1200 records the angle type to the corresponding angle flag 2410. In some embodiments, “C” can be marked in the angle flag 2410 to represent that the vertex is a convex angle, and “R” can be marked in the angle flag 2410 to represent that the vertex is a reflex angle. In some embodiments, when the angle flag 2410 has a size of one bit, “1” can be marked in the angle flag 2410 to represent that the vertex is a convex angle, and “0” can be marked in the angle flag 2410 to represent that the vertex is a reflex angle.

The ear calculator 1300 can determine whether a vertex is an ear of the polygon. If the vertex is the ear of the polygon, the ear calculator 1300 marks the ear flag 2430 corresponding to the vertex. It is understood that, in some embodiments, the ear calculator 1300 determines whether a vertex is an ear of the polygon by determining whether the angle type of the vertex is a convex angle, and no other vertex of the polygon exists in the triangle form by the vertex and two connected vertices. The ear calculator 1300 can directly check whether the corresponding angle flag 2410 is marked as “C” or “1” to determine whether the angle type of the vertex is a convex angle. When the angle type of the vertex is a convex angle, and no other vertex of the polygon exists in the triangle form by the vertex and two connected vertices, the ear calculator 1300 determines that the vertex is the ear of the polygon. In some embodiments, if the vertex is the ear of the polygon, the ear flag 2430 corresponding to the vertex can be marked, or marked as “1”. If the vertex is not the ear of the polygon, the ear flag 2430 corresponding to the vertex is not marked, or marked as “0”.

The triangle selector 1400 can scan the indicators 2400 of all storage units 2000 to check whether the ear flag 2430 of any vertex is marked, or marked as “1”. That is, the triangle selector 1400 checks whether any vertex of the polygon is an ear. When the ear flag 2430 of a specific vertex is marked, or marked as “1”, the triangle selector 1400 clips the specific vertex from the polygon, and marks the clip flag 2420 corresponding to the specific vertex. In some embodiments, if the vertex is clipped, the clip flag 2420 corresponding to the vertex can be marked, or marked as “1”. If the vertex is not clipped, the clip flag 2420 corresponding to the vertex is not marked, or marked as “0”. It is understood that, the angle calculator 1200, the ear calculator 1300, and the triangle selector 1400 will skip the vertex data with the marked clip flag 2420, or clip flag 2420 marked as “1” in the storage unit 200, in the subsequent triangulation process. In some embodiments, the triangle selector 1400 can record the clipped vertex and its two connected vertices, or output the clipped vertex and its two connected vertices to a rendering unit for rendering.

It is understood that, when the triangle selector 1400 clips the specific vertex from the polygon, the angle calculator 1200 can re-calculate the angle type of the respective vertex connected with the specific vertex, and record the angle type to the corresponding angle flag. Additionally, the ear calculator 1300 can determine whether the respective vertex connected with the specific vertex is an ear of the polygon after the specific vertex is clipped (polygon without the selected vertex). If the vertex connected with the specific vertex is the ear of the polygon after the specific vertex is clipped (polygon without the selected vertex), the corresponding ear flag 2430 is marked. The triangulation process is repeated until the number of vertices of the polygon is less than or equal to 3. It is understood that, in some embodiments, the number of remnant vertices of the polygon can be known by checking the clip flags. That is, the number of vertices whose clip flags are not marked or marked as “0” is the number of remnant vertices of the polygon. It is noted that, in some embodiments, the indicator 2400 may not have the clip flag 2420. When the indicator 2400 does not have the clip flag 2420, the information regarding whether a vertex is clipped can be recorded via software.

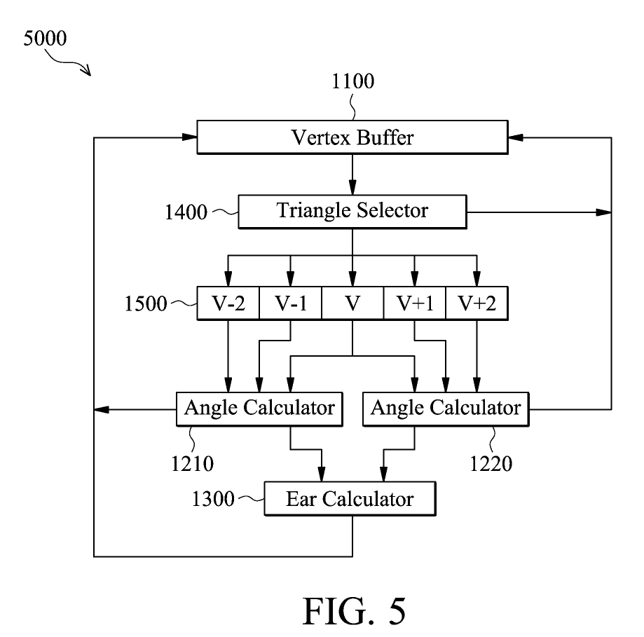

In some embodiments, the triangulation processing system 1000 may comprises an intermediate buffer (not shown in FIG. 1). The triangle selector 1400 can first select a specific number of vertex data according to the size of the intermediate buffer, and store the selected vertex data to the intermediate buffer. The angle calculator 1200 can read the vertex information from the intermediate buffer, and accordingly perform related calculations. In the embodiments, the number of the angle calculators 1200 can be also designed according to the size of the intermediate buffer. FIG. 5 is a schematic diagram illustrating another embodiment of a triangulation processing system of the invention. As shown in FIG. 5, the triangulation processing system 5000 comprises a vertex buffer 1100, a triangle selector 1400, an intermediate buffer 1500, angle calculators 1210 and 1220, and an ear calculator 1300. The size of the intermediate buffer 1500 is 5 units (V−2, V−1, V, V+1 and V+2, for respectively storing information of 5 vertices). In this embodiment, the triangulation process can be sped up. It is understood that, the number of the angle calculators is not limited thereto, and may be adjusted according to different applications and requirements.

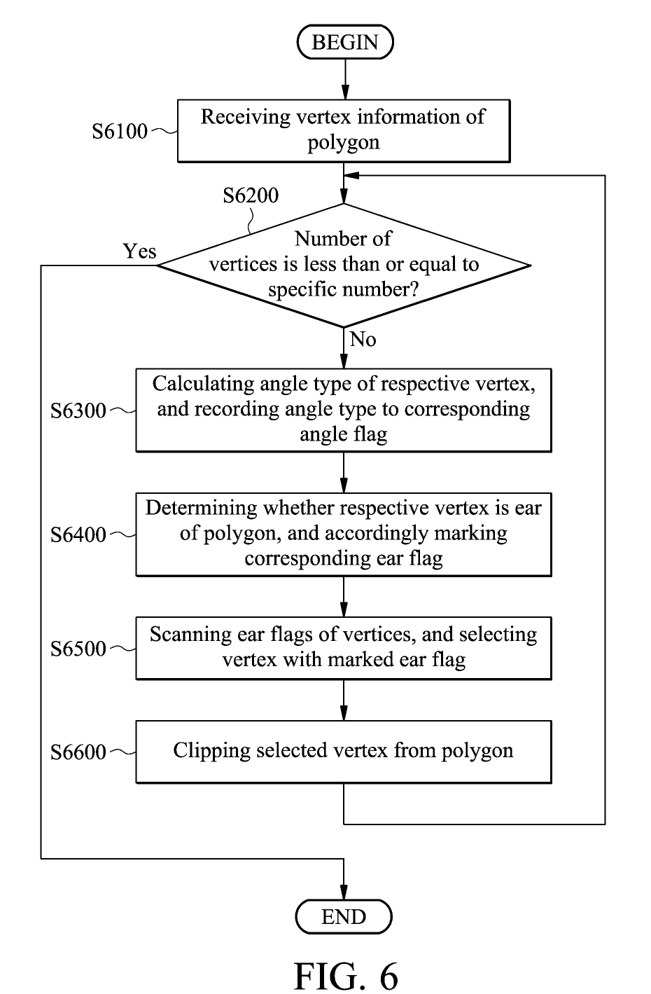

FIG. 6 is a flowchart of an embodiment of a triangulation processing method of the invention.

In step S6100, information of a plurality of vertices of a polygon is received. The information of each vertex comprises coordinates at X, Y and Z axes, and an angle flag, a clip flag, and an ear flag. It is understood that, the angle flag, the clip flag, and the ear flag can be hardware-implemented or software-implemented. In step S6200, it is determined whether the number of vertices of the polygon is less than or equal to a specific number, such as 3. It is noted that, the number of vertices of the polygon can be determined according to the clip flags of the vertices, wherein when a vertex is clipped from the polygon during the triangulation process, and the clip flag corresponding to the clipped vertex is marked. When the number of vertices of the polygon is less than or equal to the specific number (Yes in step S6200), the procedure is completed. When the number of vertices of the polygon is not less than or equal to the specific number (No in step S6200), in step S6300, an angle type of the respective vertex is calculated according to the information of the vertices, and the angle type is recorded to the corresponding angle flag. Similarly, the angle type may comprise a convex angle and a reflex angle, and the angle type of the respective vertex can be calculated according to the information, such as coordinates of the vertex and its connected vertices. In step S6400, it is determined whether the respective vertex is an ear of the polygon according to the angle type of the respective vertex and the information of the connected vertices, and the corresponding ear clip is accordingly marked. In some embodiments, when the angle type of the vertex is a convex angle, and no other vertex of the polygon exists in the triangle form by the vertex and two connected vertices, the vertex is determined as the ear of the polygon. In step S6500, the ear flags of the respective vertices are scanned, and one of the vertices with marked ear flags is selected. In step S6600, the selected vertex is clipped from the polygon. Similarly, after the vertex is clipped from the polygon, the clip flag corresponding to the clipped vertex is marked. Then, the procedure returns to step S6200 to continue the triangulation process for the polygon. In some embodiments, the clipped vertex and its two connected vertices can be recorded, or output to a rendering unit for rendering.

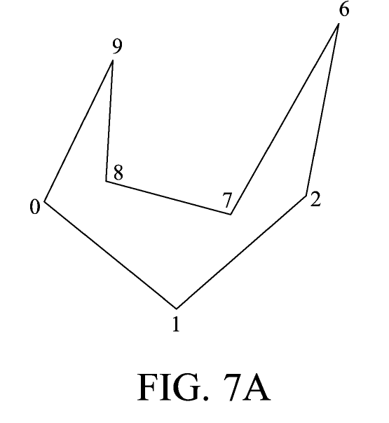

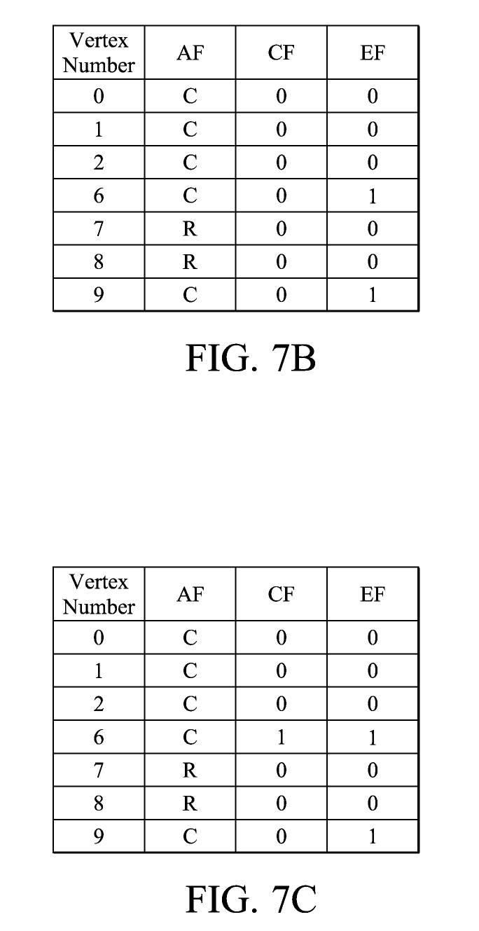

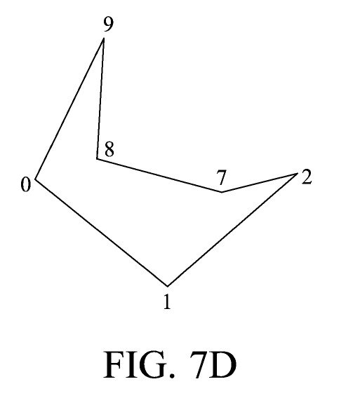

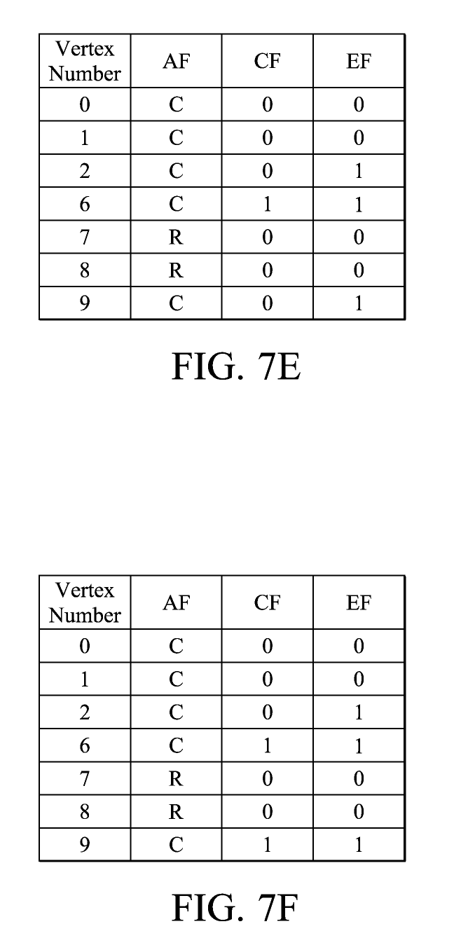

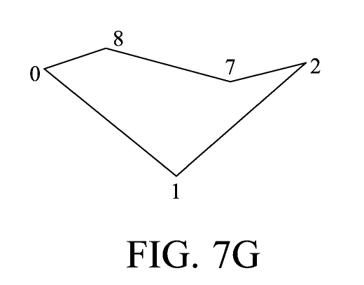

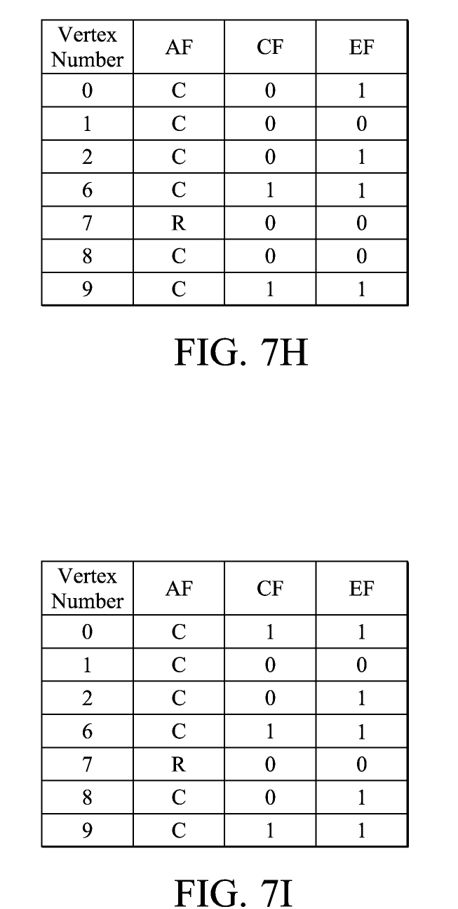

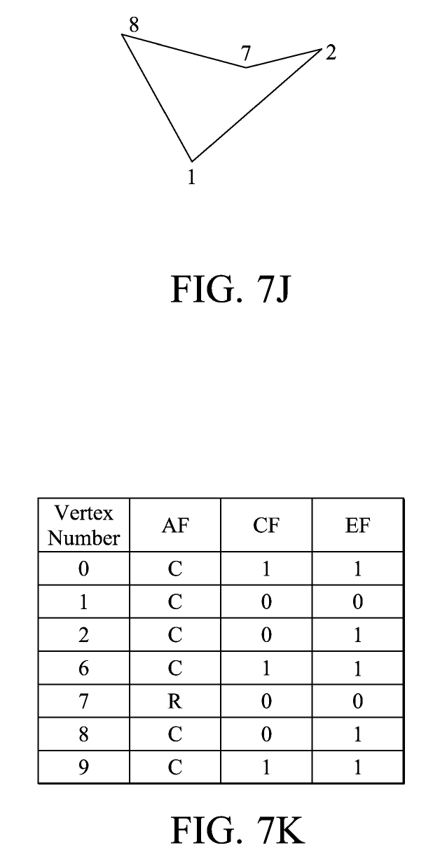

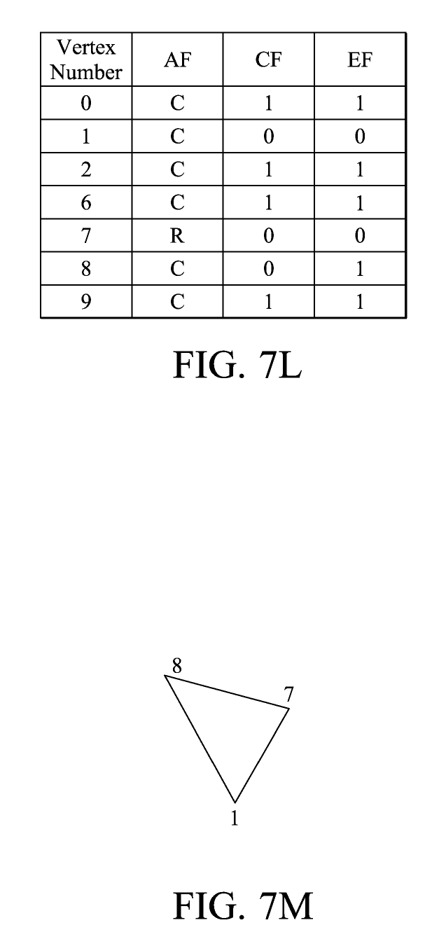

An example as follow. FIGS. 7A˜7M are schematic diagrams illustrating an example of a triangulation process according to the embodiment of the invention. The system receives vertex information of a polygon as shown in FIG. 7A, wherein the polygon includes 9 vertices, and the angle flags AF, the clip flags CF, and the ear flags EF of the respective vertices are shown in FIG. 7B. The angle flags AF with a mark “C” means that the angle type is a convex angle, and the angle flags AF with a mark “R” means that the angle type is a reflex angle. When a vertex is clipped from the polygon, the corresponding clip flag CF is marked as “1”. When a vertex is the ear of the polygon, the corresponding ear flag EF is marked as “1”. In this example, vertices 0, 1, 2, 6 and 9 are convex angles, vertices 7 and 8 are reflex angles, and vertices 6 and 9 are ears of the polygon.

First, the ear flags EF of all vertices are scanned to know vertex 6 is an ear. Then, vertex 6 is clipped from the polygon, and the clip flag CF of vertex 6 is marked as “1”, as shown in FIG. 7C. The polygon, after vertex 6 has been clipped, is shown in FIG. 7D. Then, the angle types of vertices 2 and 7 connected with vertex 6 are re-calculated, and it is determined whether vertices 2 and 7 have become ears of the new polygon (after vertex is clipped). After vertex 6 is clipped, the angle types of vertices 2 and 7 are not changed, but vertex 2 becomes the ear of the new polygon. Therefore, the ear flag EF of vertex 2 is updated, as shown in FIG. 7E. Then, the ear flags EF of all vertices are scanned to know vertex 9 is an ear. Next, vertex 9 is clipped from the polygon, and the clip flag CF of vertex 9 is marked as “1”, as shown in FIG. 7F. The polygon, after vertex 9 has been clipped, is shown in FIG. 7G. Then, the angle types of vertices 0 and 8 connected with vertex 9 are re-calculated, and it is determined whether vertices 0 and 8 have become ears of the new polygon. After vertex 9 is clipped, the angle type of vertices 0 is not changed, but the angle type of vertices 8 becomes a convex angle. Therefore, the angle flag AF of vertex 8 is updated as “C”. Additionally, vertices 0 and 8 become the ears of the new polygon. Therefore, the ear flags EF of vertices 0 and 8 are updated, as shown in FIG. 7H. Then, the ear flags EF of all vertices are scanned to know vertex 0 is an ear. Vertex 0 is clipped from the polygon, and the clip flag CF of vertex 0 is marked as “1”, as shown in FIG. 7I. The polygon, after vertex 0 has been clipped, is shown in FIG. 7J. Then, the angle types of vertices 8 and 1 connected with vertex 0 are re-calculated, and it is determined whether vertices 8 and 1 have become ears of the new polygon. After vertex 0 is clipped, the angle types of vertices 8 and 1 are not changed, and vertex 8 is still the ear of the new polygon, and vertex 1 is still not the ear of the new polygon. Therefore, the angle flags AF and the ear flags EF of vertices 8 and 1 does not need to be updated, as shown in FIG. 7K. Then, the ear flags EF of all vertices are scanned to know vertex 2 is an ear. Then, vertex 2 is clipped from the polygon, and the clip flag CF of vertex 2 is marked as “1”, as shown in FIG. 7L. The polygon, after vertex 2 has been clipped, is shown in FIG. 7M. Since the number of the remnant vertices of the polygon is three, the triangulation process for the polygon is completed.

Therefore, the triangulation processing systems and methods can perform the triangulation of polygons utilizing a hardware-implemented or software-implemented indicator, thus improving the efficiency of the triangulation process.

Triangulation processing systems and methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A triangulation processing system, comprising:
a vertex buffer comprising a plurality of storage units to store information of a plurality of vertices of a polygon, wherein each storage unit has an indicator comprising at least an angle flag and an ear flag;
an angle calculator calculating an angle type of the respective vertex according to the information of the vertices, and recording the angle type to the corresponding angle flag of the respective vertex;
an ear calculator determining whether the respective vertex is an ear of the polygon, and when the vertex is the ear of the polygon, marking the corresponding ear flag of the respective vertex; and
a triangle selector scanning the indicator of the respective storage unit, and selecting one of the vertices with the marked ear flags, and clipping the selected vertex from the polygon.

2. The system of claim 1, wherein each indicator further comprises a clip flag, and the triangle selector marks the clip flag corresponding to the selected vertex after the selected vertex is clipped from the polygon.

3. The system of claim 1, wherein the triangle selector records the selected vertex and the vertices connected with the selected vertex, or outputs the selected vertex and the vertices connected with the selected vertex for rendering.

4. The system of claim 1, wherein the angle calculator further calculates the angle type of the respective vertex connected with the selected vertex, and records the angle type to the corresponding angle flag, and the ear calculator further determines whether the respective vertex connected with the selected vertex is the ear of the polygon after the selected vertex is clipped, and marks the corresponding ear flag when the vertex connected with the selected vertex is the ear of the polygon after the selected vertex is clipped.

5. The system of claim 1, wherein the ear calculator determines whether the respective vertex is the ear of the polygon by determining whether the angle type of the vertex is a convex angle, and no other vertex of the polygon exists in a triangle form by the vertex and two connected vertices, and determines the respective vertex is the ear of the polygon when the angle type of the vertex is the convex angle, and no other vertex of the polygon exists in the triangle form by the vertex and two connected vertices.

6. The system of claim 1, wherein the angle calculator calculates the angle type of the respective vertex according to the information of the vertices connected with the vertex, wherein the angle type comprises a convex angle and a reflex angle.

7. The system of claim 1, wherein the information of the respective vertex comprises coordinates of the vertex.

8. A triangulation processing method, comprising:
receiving information of a plurality of vertices of a polygon, wherein each vertex comprises at least an angle flag and an ear flag;
calculating an angle type of the respective vertex according to the information of the vertices, and recording the angle type to the corresponding angle flag of the respective vertex;
determining whether the respective vertex is an ear of the polygon;
marking the corresponding ear flag of the respective vertex when the vertex is the ear of the polygon;
scanning the indicator of the respective storage unit, and selecting one of the vertices with the marked ear flags; and
clipping the selected vertex from the polygon.

9. The method of claim 8, wherein each vertex further comprises a clip flag, and the method further comprises, after the selected vertex is clipped from the polygon, marking the clip flag corresponding to the selected vertex.

10. The method of claim 8, further comprising recording the selected vertex and the vertices connected with the selected vertex, or outputting the selected vertex and the vertices connected with the selected vertex for rendering.

11. The method of claim 8, further comprising:
calculating the angle type of the respective vertex connected with the selected vertex;
recording the angle type to the corresponding angle flag;
determining whether the respective vertex connected with the selected vertex is the ear of the polygon after the selected vertex is clipped; and
marking the corresponding ear flag when the vertex connected with the selected vertex is the ear of the polygon after the selected vertex is clipped.

12. The method of claim 8, wherein the determination of whether the respective vertex is the ear of the polygon is performed by the steps of:
determining whether the angle type of the vertex is a convex angle, and no other vertex of the polygon exists in a triangle form by the vertex and two connected vertices; and
determining the respective vertex is the ear of the polygon when the angle type of the vertex is the convex angle, and no other vertex of the polygon exists in the triangle form by the vertex and two connected vertices.

13. The method of claim 8, wherein calculation of the angle type of the respective vertex is performed according to the information of the vertices connected with the vertex, wherein the angle type comprises a convex angle and a reflex angle.

14. The method of claim 8, wherein the information of the respective vertex comprises coordinates of the vertex.

15. A machine-readable storage medium comprising a computer program, which, when executed, causes a device to perform a triangulation processing method, wherein the method comprises:
receiving information of a plurality of vertices of a polygon, wherein each vertex comprises at least an angle flag and an ear flag;
calculating an angle type of the respective vertex according to the information of the vertices, and recording the angle type to the corresponding angle flag of the respective vertex;
determining whether the respective vertex is an ear of the polygon;
marking the corresponding ear flag of the respective vertex when the vertex is the ear of the polygon;
scanning the indicator of the respective storage unit, and selecting one of the vertices with the marked ear flags; and
clipping the selected vertex from the polygon.
